(19) United States
(12) Patent Application Publication
(10) Pub. No.: US 2022/0202114 A1
(43) Pub. Date: Jun. 30, 2022

(54) PACK FRAME ILLUMINATED WITH WIRELESS VEHICLE SIGNALING SYSTEM AND HAVING DETACHABLE ACCESSORY PACKS

(71) Applicant: Brian Jon Garvey, Spokane, WA (US)

(72) Inventor: Brian Jon Garvey, Spokane, WA (US)

(21) Appl. No.: 17/565,791

(22) Filed: Dec. 30, 2021

Related U.S. Application Data
(60) Provisional application No. 63/133,217, filed on Dec. 31, 2020.

(51) Int. Cl. A41D 13/01; G08B 5/00; G08B 5/38

(52) U.S. Cl. CPC A41D 13/01; G08B 5/38; G08B 5/004

(57) ABSTRACT

A pack frame for vehicle riders or users on foot forms an X-shaped shell securing different types of detachable accessory packs between the frame and the rider. The detachable accessory packs are secured to the X-shaped frame with cam and collar mechanisms. The detachable accessory packs include a daypack, weekend pack, hydropack, and skatepack, for example. In an implementation, the pack frame forming the X-shaped shell is illuminated by signal lights and a wireless system to mirror traffic signaling of the user's vehicle, such as a motorcycle. The signal lights of the pack frame are adjustable and user-mappable to the vehicle's signaling via a mobile application. A curved and X-shaped brake light on the frame makes the rider of a motorcycle visible from many different viewpoints around the rider.

### RELATED APPLICATIONS

This nonprovisional patent application claims the benefit of priority to U.S. Provisional Patent Application No. 63/133,217 to Garvey, filed Dec. 31, 2020, which is incorporated herein by reference in its entirety.

### BACKGROUND

Riders of motorcycles, bicycles, and other vehicles often wear a backpack or other type of pack to carry articles, especially when the vehicle lacks a significant storage trunk or cargo bed. There are many reasons for riders to outfit themselves with various types of backpacks, and so there is no one-size-fits-all backpack sufficient to cover all popular uses.

### BRIEF DESCRIPTION OF THE DRAWINGS

This disclosure makes reference to the accompanying drawings showing one or more embodiments, wherein like reference numerals denote like elements. The accompanying figures illustrate the various implementations described herein and are not meant to limit the scope of the various technologies described.

FIG. 1 is a diagram of an example X-pack frame for walkers, hikers, and riders of motorcycles, bicycles, ATVs, and other vehicles and sport equipment, compatible with detachable and interchangeable accessory packs.

FIG. 2 is a diagram of a first detachable accessory pack for use as a daypack with the example X-pack frame.

FIG. 3 is a diagram of a second detachable accessory pack for use as a weekend pack with the example X-pack frame.

FIG. 4 is a diagram of a third detachable accessory pack for use as a hydropack with the example X-pack frame.

FIG. 5 is a diagram of a fourth detachable accessory pack for use as a skatepack with the example X-pack frame.

FIG. 6 is a diagram of an example illuminated X-pack frame for riders of motorcycles, bicycles, ATVs, and other vehicles and sport equipment, illuminated with signal lights for vehicular traffic signaling.

FIG. 7 is a diagram of a first detachable accessory pack for use as a daypack with the example illuminated X-pack frame with vehicular traffic signaling capability.

FIG. 8 is a diagram of a second detachable accessory pack for use as a weekend pack with the example illuminated X-pack frame with vehicular traffic signaling capability.

FIG. 9 is a diagram of a third detachable accessory pack for use as a hydropack with the example illuminated X-pack frame with vehicular traffic signaling capability.

FIG. 10 is a diagram of a fourth detachable accessory pack for use as a skatepack with the example illuminated X-pack frame with vehicular traffic signaling capability.

FIG. 11 is a diagram of an example user interface for selecting a transportation mode for linking signal lights of an illuminated X-pack with traffic signaling of a vehicle.

FIG. 12 is a diagram of an example user interface for programming behaviors of signal lights of the example illuminated X-pack.

FIG. 13 is a diagram of an example vehicular signal and lighting system configurable to the example illuminated X-pack and to various illuminated articles and apparel.

### DETAILED DESCRIPTION

### Overview

This disclosure describes a frame apparatus (X-pack frames 100 and 600) for walkers, hikers, and riders of motorcycles, bicycles, ATVs, and other vehicles, that has detachable and interchangeable accessory packs. The example X-pack frame 100, 600 and one of an assortment of detachable and interchangeable accessory packs form an instance of a complete backpack assembly (the “X-pack”).

X-pack frame 100 can swap between interchangeable accessory packs to become different instances of the X-pack with different functions, such as daypack, weekend pack, hydropack, or skatepack, for example.

In an implementation, the X-pack frame 600 is illuminated with signal lights controlled via a wireless signaling system to provide vehicular signaling capability, such as brake lights, turn signals, headlights, running lights, emergency lights, etc. The visibility of signal lights on motorcycles, bicycles, ATVs, and scooters is inherently insufficient because these are smaller than cars and trucks. Often all the lights on a conventional motorcycle, for example, are below the level of the rider's bodily waistline, so it can be difficult for other drivers to see when the vehicle is signaling a turn, or braking to slow down or stop, especially if an intervening vehicle is blocking an observer's view of the rider's vehicle.

### Example Systems

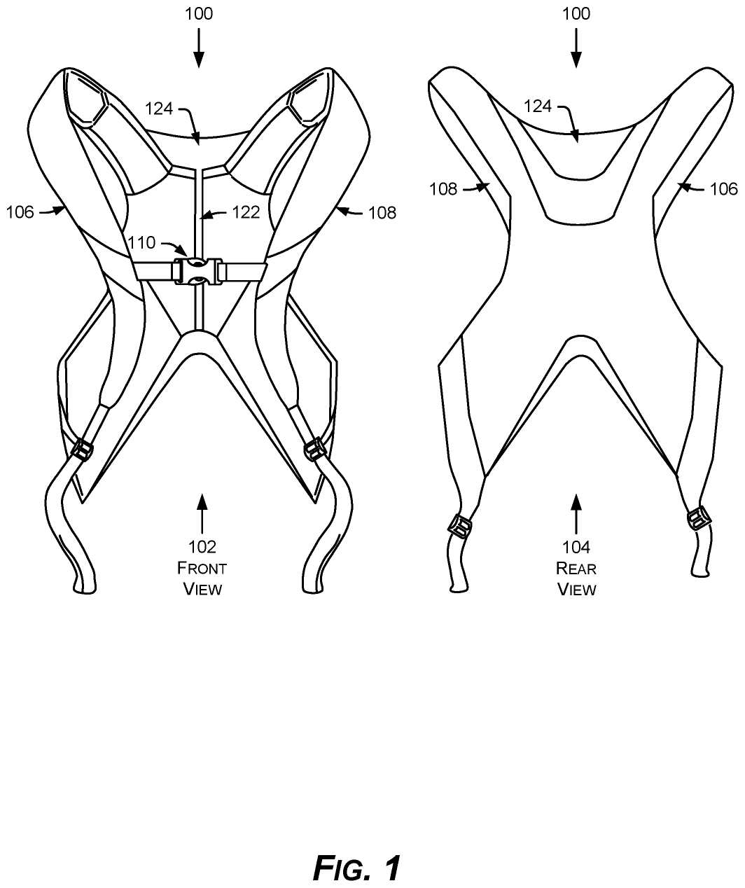

FIG. 1 shows an example X-pack frame 100 from a front view 102 and a rear view 104. In an implementation, the X-pack frame 100 forms an X-shaped shell. The X-pack frame 100 receives one of the assortment of detachable accessory packs (see following Figures) to become a complete backpack assembly unit or “X-pack” for a given use or for a given trip of the walker, hiker, or rider. The X-pack frame 100 has shoulder straps 106, 108 and support members forming an X shape, which provides several advantages.

A keyslot, slotted groove, or notch 122 in a surface of the X-pack frame 100 that faces the back of the rider, receives and stabilizes one of the detachable accessory packs, which compatibly slides into the notch 122 of the X-pack frame 100 and is conformable to the shape of the X-pack frame 100.

Each detachable accessory pack is configured to fit between the rider's back and the X-pack frame 100. This is different from conventional frame backpacks, which have the frame next to the rider, with the storage pack as the outermost part of the combination. The X-pack frame 100 is the outermost rear member of the X-pack's complete pack assembly that is formed by the combination of the X-pack frame 100 and one of the accessory packs. The X-pack frame 100 faces traffic behind the rider.

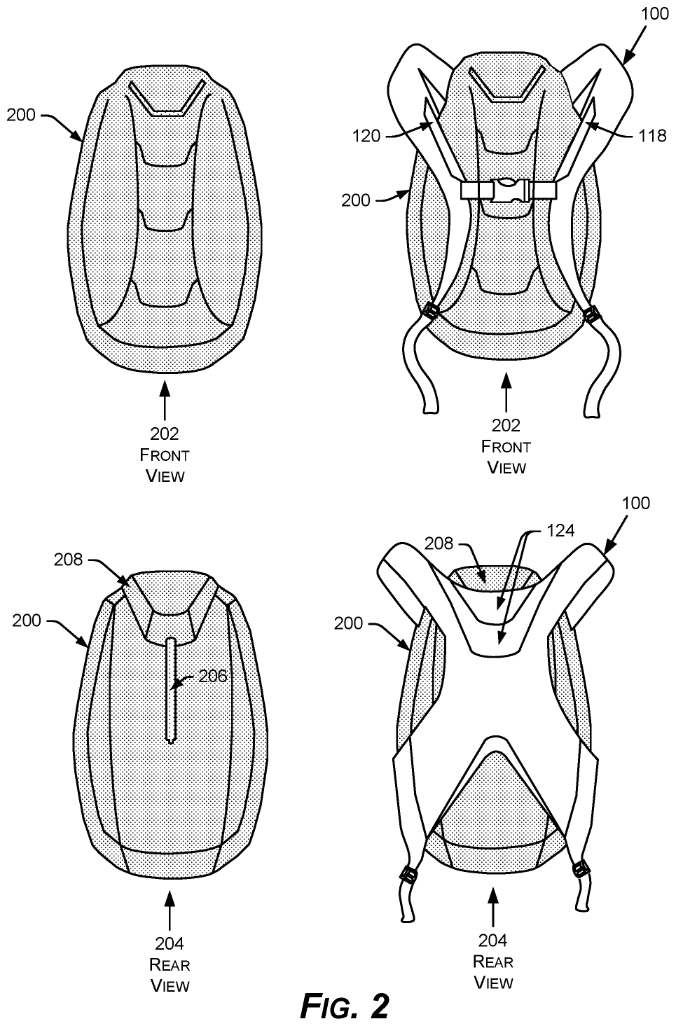

In addition to the notch 122 of the X-pack frame 100 that keys to each of the assorted detachable accessory packs, an upper collar 124 of the X-pack frame 100 also receives, seats, and secures each detachable accessory pack. Thus, each detachable accessory pack has a neck portion 208 (FIG. 2) shaped to fit the collar 124 of the X-pack frame 100, for seating and locking the detachable accessory pack into the X-pack frame 100. The detachable accessory packs each provide a unique utility, such as providing different amounts of storage space, ability to pack liquids, or ability to carry large or unusually shaped items, such as skateboards, keyboards, and so forth.

In FIG. 1, the X-pack frame 100 is capable of being worn by a person, whether the person is a rider of a vehicle or not. The complete X-pack may also have utility for users of sports equipment, such as skis, skates, snowboards, personal watercraft, snowmobiles, and so forth. The detachable and interchangeable accessory packs can be made waterproof or otherwise made suitable for a particular environment.

The shoulder straps 106, 108 may be flexible or partially solid depending on implementation. The shoulder straps 106, 108 may be accompanied by one or more claspable cross-straps 110 between the shoulder straps 106, 108, to secure the shoulder straps 106, 108 to each other, or to form a front harness.

The shoulder straps 106, 108 of the X-pack frame 100 and the supporting members of the X-pack frame 100 form an X shape. This X shape provides several advantages such as low weight, easy visibility to other drivers when the detachable accessory packs are attached to the frame 100, and ergonomic flexibility for the rider or wearer of the X-pack. Implementations of the detachable accessory packs are described below.

FIG. 2 shows a first detachable accessory pack 200 for use as a daypack with the example X-pack frame 100. FIG. 2 shows the first detachable accessory pack 200 from a front view 202 and a rear view 204. Structurally, in various implementations, the X-pack frame 100 has the notch 122 for slidably receiving and stabilizing a corresponding fin, key, or cam 206 residing on each of the multiple detachable accessory packs that can be used with the X-pack frame 100, including the first detachable accessory pack 200 of FIG. 2. Each unique detachable accessory pack has a general shape that is conformable to the interior contours of the X-pack frame 100.

The upper collar 124 of the X-pack frame 100 seats and stabilizes the neck portion 208 of the first detachable accessory pack 200. The shaped neck portion 208 of the first detachable accessory pack 200 fits onto the shape of the collar 124 of the X-pack frame 100 and seats there, while the cam 206 feature of the first detachable accessory pack 200 slides into the notch 122 of the frame 100. The collar 124 and the notch 122 of the X-pack frame 100 thereby stabilize and secure the first detachable accessory pack 200 onto the X-pack frame 100.

In an implementation, the X-pack frame 100 itself has an inherent storage space, such as one or more pockets or compartments for small items such as keys, smart phone, wallet, glasses, and so forth.

The first detachable accessory pack 200 is a daypack capable of holding and carrying a certain amount of goods, as might be desirable for a short day trip, such as food, clothes, and accessories to last about one day. The first detachable accessory pack 200 may be made of flexible or solid materials, or a combination of both, depending on implementation.

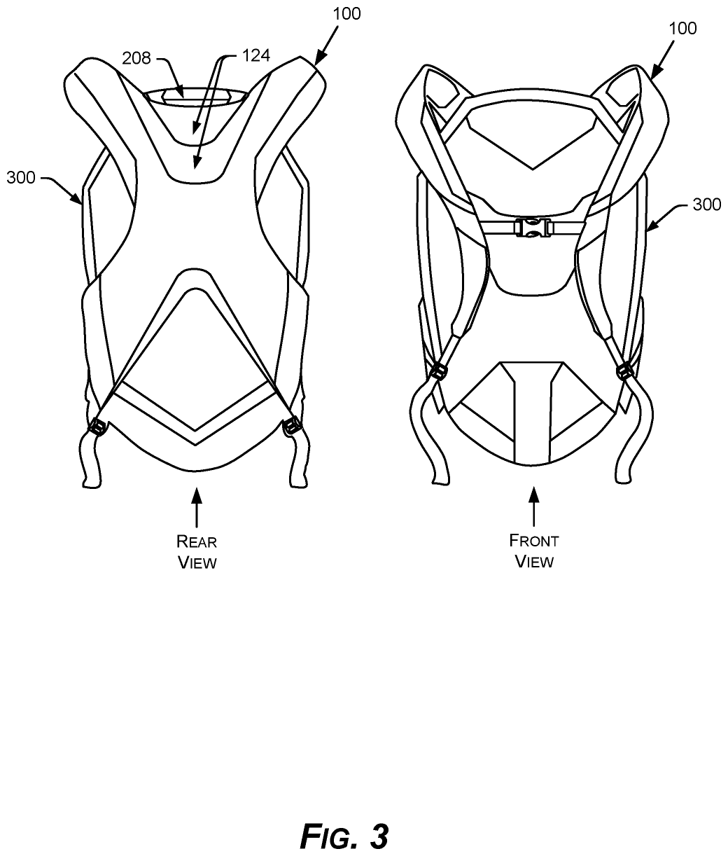

FIG. 3 shows a second example detachable accessory pack 300, dubbed a “weekend pack,” with a larger storage and carrying capacity than the first detachable accessory pack 200 (daypack) of FIG. 2. The second detachable accessory pack 300 is capable of holding and carrying a certain amount of goods as might be suitable for carrying food, clothing, accessories, shelter equipment (e.g., tent), and cooking equipment to last multiple days, for a camping trip or multi-day road trip, for example. The second detachable accessory pack 300 may be made of flexible or solid materials, or a combination of both, depending on implementation. The second example detachable accessory pack 300 has the cam 206, formed to fit into the notch 122 of the X-pack frame 100, and has the neck portion 208 formed to fit into and onto the collar 124 of the X-pack frame 100. The second detachable accessory pack 300 is generally conformable to the X-pack frame 100 and strapped onto the rider's back by the X-pack frame 100 and its shoulder straps 106, 108. The first mating between the cam 206 of the second accessory pack 300 and the notch 122 of the X-pack frame 100, and the second mating between the neck portion 208 of the second accessory pack 300 and the collar 124 of the X-pack frame 100 provide a stable lock between the second detachable accessory pack 300 and the X-pack frame 100.

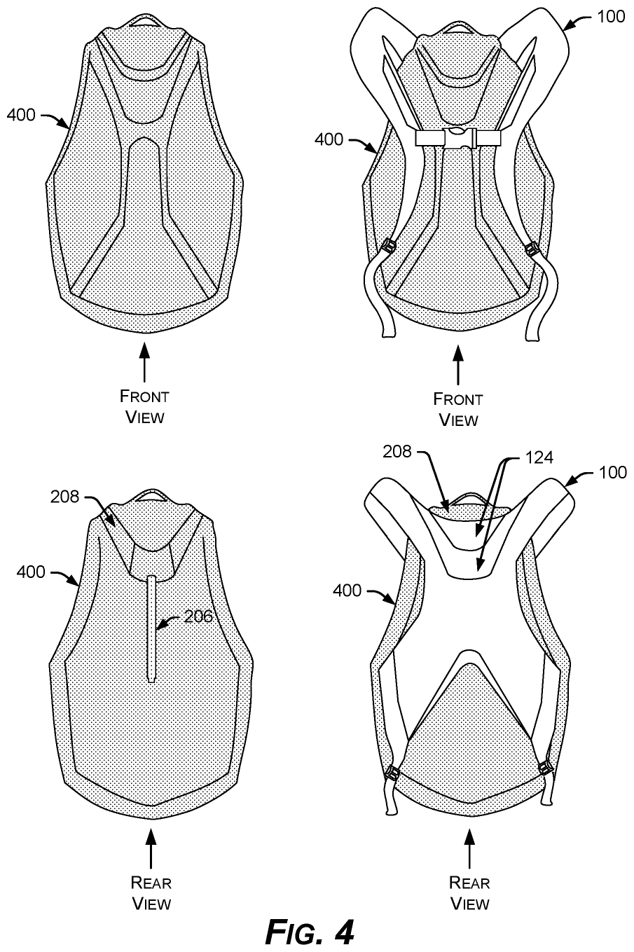

FIG. 4 shows a third example detachable accessory pack 400, dubbed a “hydropack,” for carrying or transporting water or another drink or liquid. The third detachable accessory pack 400 may be made of flexible or solid materials, or a combination of both, depending on implementation. The third example detachable accessory pack 400 has the cam 206, formed to fit into the notch 122 of the X-pack frame 100, and has the neck portion 208 formed to fit into and onto the collar 124 of the X-pack frame 100. The third detachable accessory pack 400 is generally conformable to the X-pack frame 100 and strapped onto the rider's back by the X-pack frame 100 and its shoulder straps 106, 108. The first mating between the cam 206 of the third accessory pack 400 and the notch 122 of the X-pack frame 100, and the second mating between the neck portion 208 of the third accessory pack 400 and the collar 124 of the X-pack frame 100 provide a stable lock between the third detachable accessory pack 400 and the X-pack frame 100.

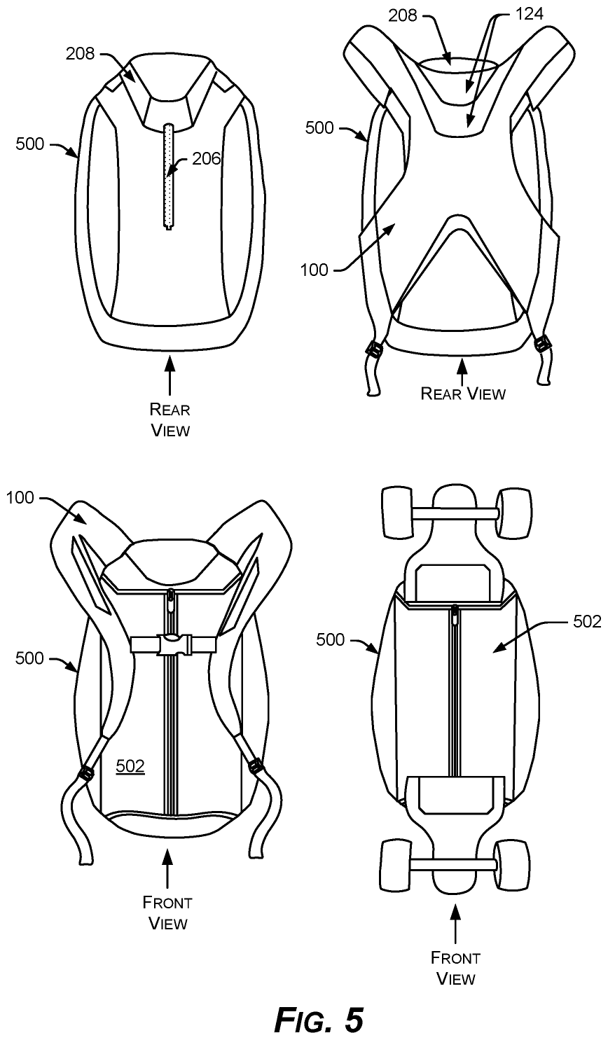

FIG. 5 shows a fourth example detachable accessory pack 500, dubbed a “skatepack,” for carrying or transporting a relatively large flat object, such as a skateboard, for example. The fourth detachable accessory pack 500 is made of flexible and solid materials, and has a sleeve 502 or pocket for securing the large flat object, or skateboard. In an implementation, the sleeve 502 of the fourth accessory pack 500 is zippered or otherwise closeable from an open state, and may be considered a large strap or belt for surrounding and securing the large object or skateboard to the fourth detachable accessory pack 500 by closing the sleeve 502 by the zipper, clasp, hook and loop fastener material, or other closing means. The sleeve 502 may secure a skateboard, for example, between sets of wheels on the skateboard when a zippered version of the sleeve 502 is zippered closed. The fourth detachable accessory pack 500 (skatepack) may also have interior storage space in its own right, besides possessing the sleeve 502 or sleeves. The backside of the fourth example detachable accessory pack 500 has the cam 206 formed to fit into the notch 122 of the X-pack frame 100, and has the neck portion 208 formed to fit into and onto the collar 124 of the X-pack frame 100, while the front side of the fourth detachable accessory pack 500 has the sleeve 502. The fourth detachable accessory pack 500 is generally conformable to the X-pack frame 100 and strapped onto the rider's back by the X-pack frame 100 and its shoulder straps 106, 108. The first mating between the cam 206 of the fourth detachable accessory pack 500 and the notch 122 of the X-pack frame 100, and the second mating between the neck portion 208 of the fourth detachable accessory pack 500 and the collar 124 of the X-pack frame 100 provide a stable lock between the fourth detachable accessory pack 500 and the X-pack frame 100.

### Illuminated Embodiments

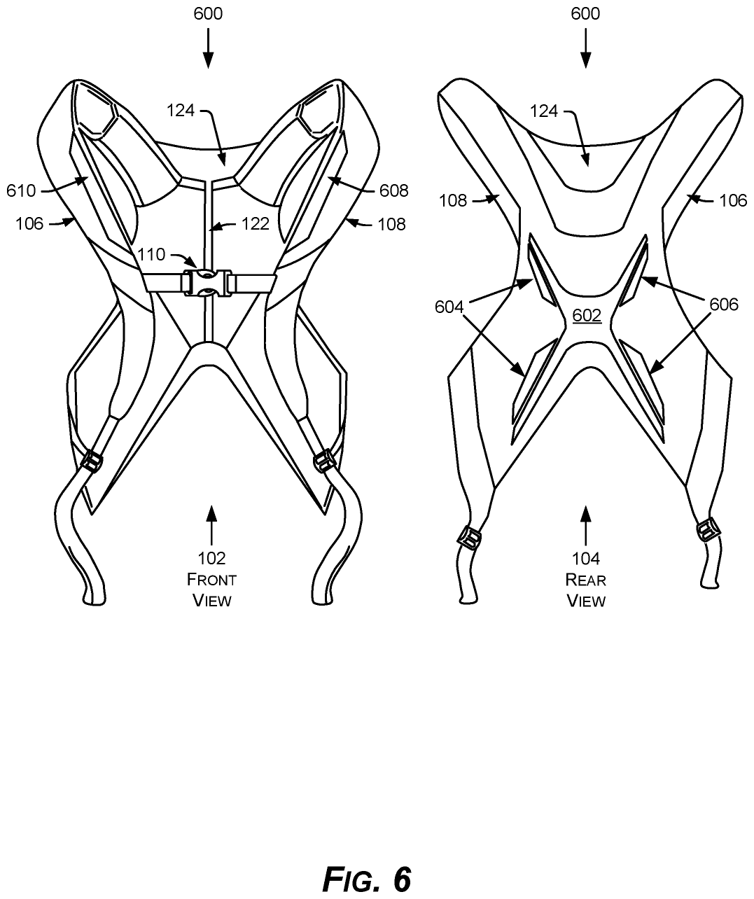

FIG. 6 shows an example illuminated embodiment of the X-pack frame 600 from a front view 102 and a rear view 104. In an implementation, the X-pack frame 600 forms an X-shaped shell. The example illuminated X-pack frame 600 receives one of the assorted detachable accessory packs to become a complete X-pack for a given use or a given trip of the walker, hiker, or rider of a vehicle. The example illuminated X-pack frame 600 has shoulder straps 106, 108 and support members forming an X shape, which provides several advantages. In this illuminated example embodiment of the X-pack frame 600, signal lights 602, 604, 606, 608, 610 of the illuminated X-pack frame 600 are capable of signaling braking (slowing and stopping), and left and right turning of the given vehicle of the user, via wireless control between the vehicle and the illuminated X-pack frame 600 being worn by the rider or user. The illuminated X-pack frame 600 also has the keyslot, groove, or notch 122 in the surface of the X-pack frame 600 that faces the rider's back, which receives and stabilizes the cam 206 of the given detachable accessory pack, which slides into the notch 122 of the illuminated X-pack frame 600 and is conformable to the illuminated X-pack frame 600.

Each detachable accessory pack is configured to fit on the rider's back, between the back of the rider and the illuminated X-pack frame 600, which forms the outer surface of the X-pack, rear-facing towards traffic behind the rider's vehicle. The straps 106, 108 of the illuminated X-pack frame 600 may also have signal lights 608, 610 depending on implementation, such as turn signals 608, 610 facing forward with respect to the rider. Forward-facing signal light 608 signals a left turn, for example, and forward-facing signal light 610 signals a right turn, for example.

The illuminated X-pack frame 600 may also have other lights, such as headlights, accessory lights, running lights, reading lights, emergency lights, auxiliary lights, and so forth, depending on implementation. A vehicle signaling system suitable for animating the lights 602, 604, 606, 608, 610 to be vehicle signal lights in real traffic is described in US Patent Publication 2019/0315268 to Garvey, which is incorporated by reference herein, in its entirety.

In FIG. 6, the illuminated X-pack frame 600 is capable of being worn by a person, whether the person is a rider or passenger of a vehicle, walking, hiking, or using some types of sports equipment. The illuminated X-pack frame 600 with one of the detachable accessory packs is useful for both carrying items and providing vehicular traffic signaling when the person is riding a vehicle such as motorcycle, bicycle, ATV, skateboard, or just walking. Likewise, the illuminated X-pack frame 600 can also provide vehicular-like traffic signaling when the rider is using sports equipment, such as skateboard, skis, skates, snowboard, and even personal watercraft, snowmobile, and so forth. The illuminated X-pack frame 600 and detachable accessory packs can be made waterproof or otherwise suitable for a particular environment.

The shoulder straps 106, 108 may be flexible, semi-flexible, or solid depending on implementation. The shoulder straps 106, 108 may be accompanied by one or more claspable cross-strap 110 between the shoulder straps 106, 108 to secure the shoulder straps 106, 108 to each other or form a front harness of the X-pack.

The shoulder straps 106, 108 of the frame 600 and the supporting members of the illuminated X-pack frame 600 form an X shape, as introduced above, which has several advantages such as low weight and easy visibility to other drivers when the detachable accessory packs are attached to the illuminated X-pack frame 600. The X shape of the illuminated X-pack frame 600 also provides ergonomic flexibility for the rider or wearer of the illuminated X-pack frame 600. The front-facing turn signal lights 608, 610 may be incorporated into the flexible, semi-flexible, or solid shoulder straps 106, 108. The illuminated X-pack frame 600 may have other front-facing lights for illumination: headlights, accessory lights, reading lights, emergency lights, and so forth, as described above.

In an implementation, the lights of the illuminated X-pack frame 600 are powered by one or more rechargeable batteries in the illuminated X-pack frame 600. In one implementation, the illuminated X-pack frame 600 also has solar cells to charge, top-off, or maintain the one or more rechargeable batteries. In an implementation, rechargeable batteries of the illuminated X-pack frame 600 are charged wirelessly by an induction coil in the illuminated X-pack frame 600, which receives power via an inductive coupling with a charging device powered by the motorcycle or other vehicle.

An electronic signaling system, such as a wireless signal controller, can control the signal lighting 602, 604, 606, 608, 610 of the illuminated X-pack frame 600 to match the signaling of the given vehicle via built-in programming or user-accessible custom programming, for example. As introduced above, an example signaling system with signal control hardware and software is described in US Patent Publication 2019/0315268 to Garvey, which is incorporated by reference in its entirety herein. The electronic signaling system and its signal controller can propagate the vehicle's own signaling (braking, slowing, stopping, turning, etc.) to the example signal lights 602, 604, 606, 608, 610 of the illuminated X-pack frame 600. The specific behavior of any given signal light on the illuminated X-pack frame 600 can be fully programmable, or can be set at the manufacturer, depending on implementation.

The signal lights of the illuminated X-pack frame 600 may alternately be programmed for entertainment, sheer visibility, or not used at all. However, programming the signal lights of the illuminated X-pack frame 600 to be vehicle signals for real traffic is provided as a primary use of signal lights 602, 604, 606, 608, 610.

Similar to the X-pack without signaling lights described in FIGS. 1-5, the example illuminated X-pack frame 600 has a notch 122 (FIG. 1) for slidably receiving and stabilizing a corresponding cam 206 (FIG. 2) residing on each of the multiple detachable accessory packs to be used with the illuminated X-pack frame 600. Implementations of the detachable accessory packs usable with the example illuminated X-pack frame 600 are shown in the following Figures. Each unique detachable accessory pack is conformable in general shape to the interior contours of the illuminated X-pack frame 600, and each detachable accessory pack is configured to fit between the rider's back and the illuminated X-pack frame 600.

At least one rear brake light 602 of the illuminated X-pack frame 600 may have an X shape or an X-shaped motif with four arms similar to the X shape of the illuminated X-pack frame 600 itself. The X shape of the rear brake light 602 may be spread in 3-dimensions over a curved surface of the X-shaped frame 600, in one implementation. Whether the X-shaped brake light 602 is curved or planar, depending on implementation, the X shape provides some practical utility benefits. When the rider turns or twists on the motorcycle or other vehicle, at least some part of the X-shaped brake light 602 is visible to another vehicle following behind, and likewise the X-shaped brake light 602 is visible to vehicles to the side and behind of the motorcycle or vehicle of the rider.

The X-shaped brake light 602 can ensure that vehicle signaling from the illuminated X-pack frame 600 is visible to other vehicles in the usual blind spots around the rider's moving vehicle. Moreover, once a driver of another vehicle observes the X shape of the rear brake light 602, then the driver of the other vehicle can judge the orientation of the rider and/or the rider's motorcycle, e.g., at night or in a fog, by visual changes in the appearance or skew of the X-shaped brake light 602, from the other driver's point of view, as the rider wearing the illuminated X-pack frame 600 changes orientation. Likewise, in some circumstances the other driver can judge the banking of a motorcycle during a turn, by the visual change in orientation of the X-shaped brake light 602. It should be noted that the X-shaped brake light 602 may be continually illuminated (red) at night or during dim light conditions, with the intensity of the illuminated red light becoming brighter during braking. This change from continuous red during normal running to intense red during braking is standard for many automobiles and motorcycles when the headlights or lights in general of the particular vehicle are turned on for night driving.

In an implementation, each of the four arms of the X-shaped brake light 602 has an associated turn signal light 604, 606, such as respective amber colored lights. The turn signal lights 604 on the rider's left side can signal a left turn, and the signal lights 606 on the rider's right side can signal a right turn. Even though the left turn signal lights 604 and the right turn signal lights 606 are relatively close together, compared to the right and left turn signal lights on a typical automobile, their angled orientation on arms of the X-shaped brake light 602 and their right or left placement with respect to the brake light itself 602 make it easy for the driver of another vehicle to discern which turn direction the illuminated X-pack frame 600 is signaling. As mentioned above, the forward-facing straps of the frame 600 may also have one or more left turn signal lights 608 and one or more right turn signal lights 610.

An electronic receiver in the X-pack frame 600 wirelessly communicates with a vehicle of the user. The signal lights on the X-pack frame 600 are actuated by the electronic receiver to duplicate a signaling of the vehicle.

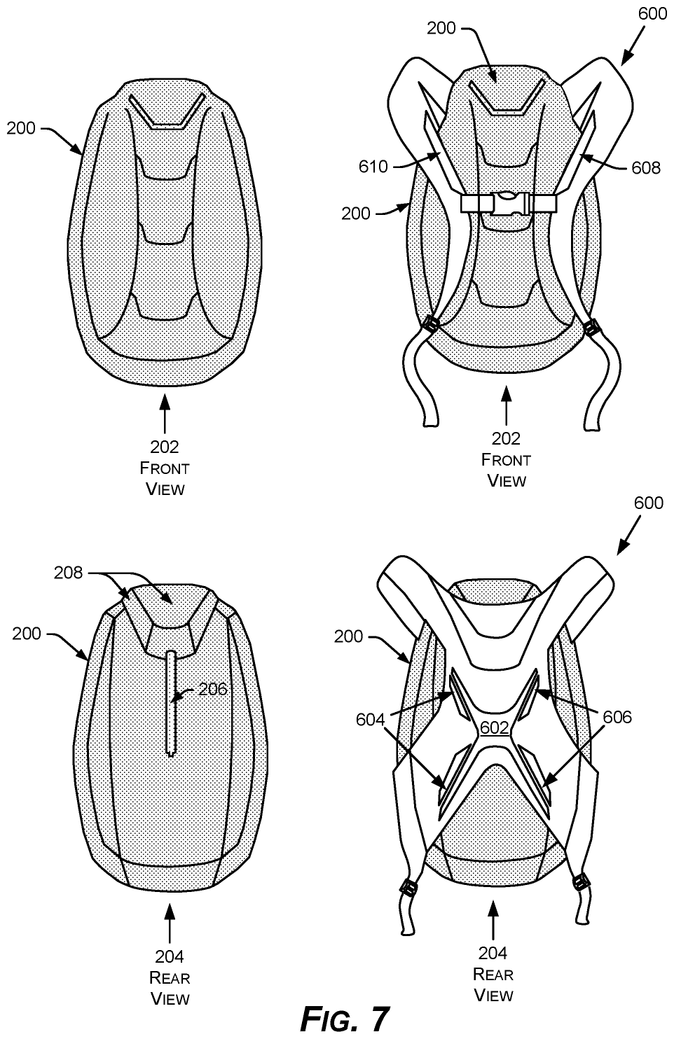

FIG. 7 shows the first detachable accessory pack 200, from a front view 202 and a rear view 204, with and without the example illuminated X-pack frame 600. The first example detachable accessory pack 200 is a daypack capable of holding and carrying a certain amount of goods, as might be desirable for a short day trip, such as food, clothes, accessories to last about one day. Further features of the first example accessory pack 200 are described above with respect to FIG. 2.

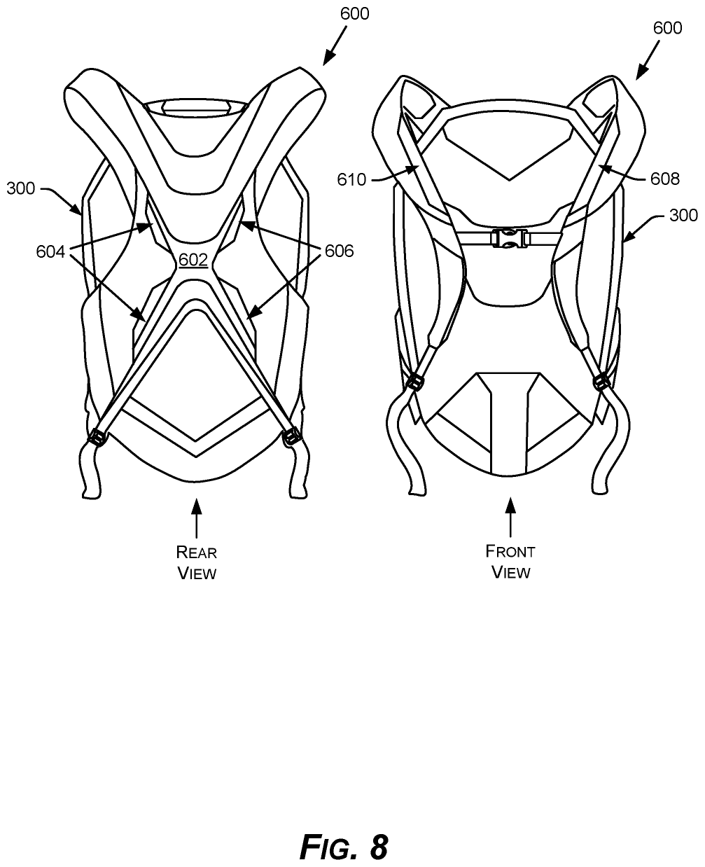

FIG. 8 shows the second example detachable accessory pack 300, dubbed a “weekend pack,” as used with the example illuminated X-pack frame 600. The second example accessory pack 300 has greater storage and more carrying capacity than the first example detachable accessory pack 200 (daypack). Further features of the second example accessory pack 300 are described above with respect to FIG. 3.

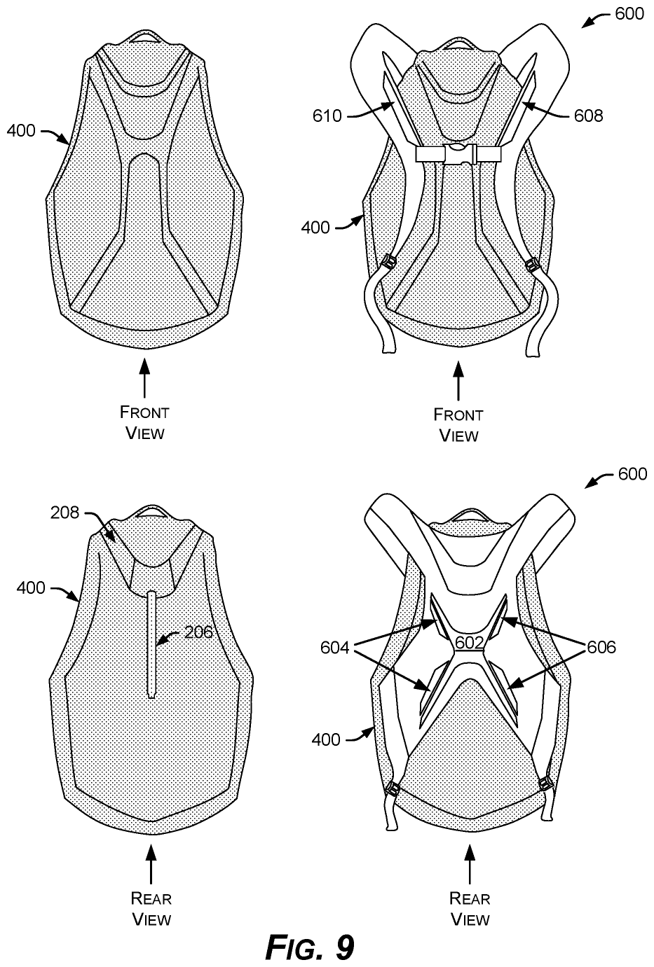

FIG. 9 shows the third example detachable accessory pack 400, dubbed a “hydropack,” with and without the example illuminated X-pack frame 600. The third example accessory pack 400 can be used for carrying or transporting water or another drink or liquid. Further features of the third example accessory pack 400 are described above with respect to FIG. 4.

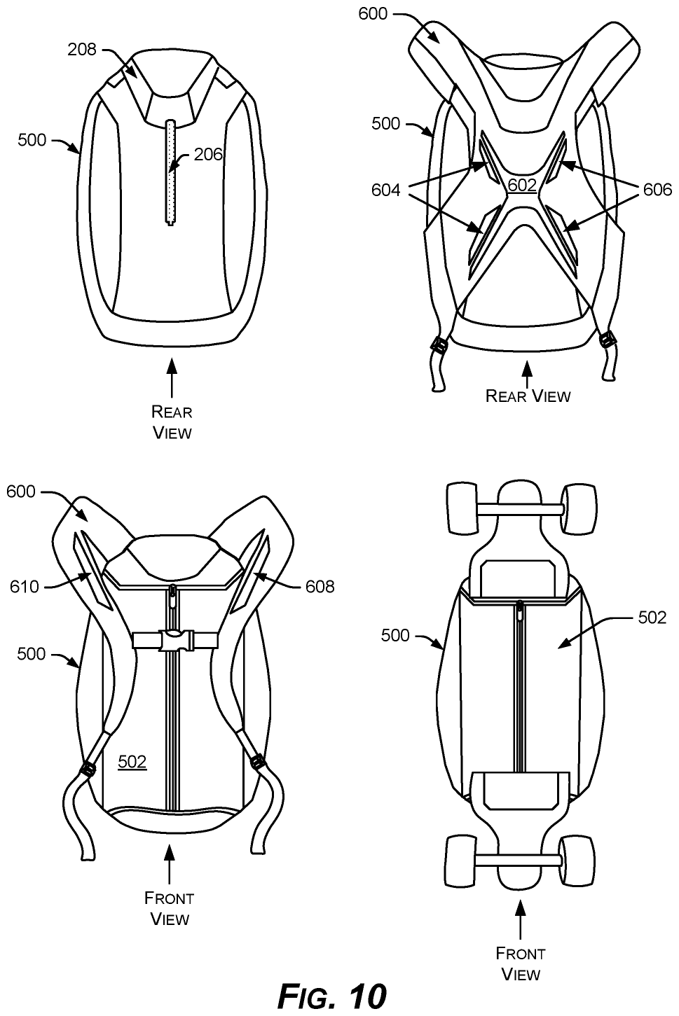

FIG. 10 shows the fourth example detachable accessory pack 500, dubbed a “skatepack,” with and without the example illuminated X-pack frame 600. The fourth example accessory pack 500 can be used for carrying or transporting a relatively large flat object, such as a skateboard, for example. Further features of the fourth example accessory pack 500 are described above with respect to FIG. 5.

### Example Remote Programmer & Mobile Application

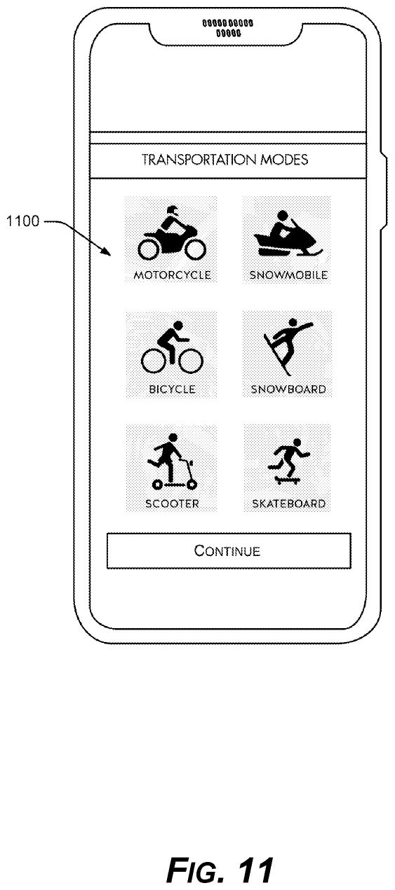

FIG. 11 shows a screenshot of an example mobile application that resides on an electronic device of the rider, or other user. An example “transportation mode” user interface 1100 of the mobile application executes on a smart phone, smart watch, or tablet hardware of the user, for wirelessly connecting the illuminated X-pack 600 between multiple different modes of transportation, such as, but not limited to a motorcycle, an ATV, a skateboard, a scooter, a moped, a snowmobile, or a bicycle, as examples.

The transportation mode user interface 1100 of the application allows the user to select the type of vehicle, and the specific vehicle, to map signaling from. For example, the user may select “motorcycle.” The hardware running the application then communicates with a transceiver on the motorcycle or on the illuminated X-pack 600, or both, to initiate pairing between the signaling of the motorcycle and the illuminated X-pack 600.

When the rider wants to use a different mode of transportation, the rider may switch transportation modes by selecting a different vehicle type, or specific vehicle, on the user interface 1100.

In an example, a rider has a motorcycle, a snowmobile, a scooter, and a moped in the rider's garage. Each vehicle has a lighting device, turn signals, and brake lighting. Each of these vehicles may be paired/synced separately to both the mobile application and the illuminated X-pack 600.

The rider then selects which vehicle to use on the user interface 1100, and the illuminated X-pack 600 wirelessly connects to that vehicle's lighting system.

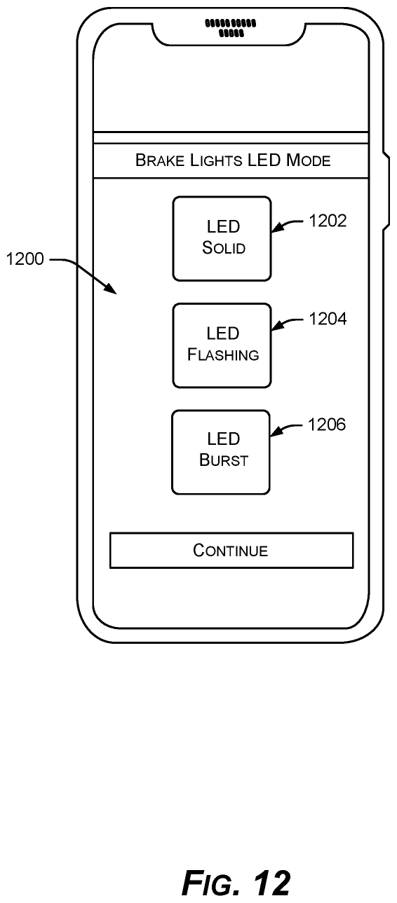

FIG. 12 shows an example user interface 1200 of the mobile application for programming features of the example signal lights 602, 604, 606, 608, 610 of the illuminated X-pack 600 (or other accessory) via the example mobile application. In an implementation, the mobile application resides on an electronic device of the rider or other user, forming a remote programmer for adjusting lighting qualities of the signal lights 602, 604, 606, 608, 610, such as color, brightness, flash, dimming features, frequency and duration of blinking, emergency blinking patterns, and so forth. The signal lights may include emergency flashers actuated by an electronic receiver or by sensors detecting an emergency circumstance.

User interface 1200 is one such example page or window of the mobile application for adjusting lighting features. The user interface 1200 allows the user to select whether brake light LEDs are illuminated in a solid mode 1202, a flashing mode 1204, or a burst mode 1206, for example. The brightness, color, and flashing parameters of the signal lights, such as frequency and duration, may also be custom-programmed by the rider or wearer via other implementations of the example user interface 1200 of the mobile application. User interface 1200, as an example instance, shows a page or window for specifying example lighting features of selected brake lights. Other versions of user interface 1200 specify features and behaviors of other lights in addition to the brake lights of the article or accessory.

In a manual-control implementation of the lighting, the signal lights 602, 604, 606, 608, 610 of the illuminated X-pack frame 600 can be controlled manually by the wearer, with manual turn signal buttons or lever, accelerometer, manual brake button, and so forth, as examples. This is useful when the vehicle or piece of sports equipment, such as skateboard, skis, skates, rollerblades, bicycle, (or just walking or running), has no signaling system of its own. Thus, the illuminated X-pack frame 600 may be used without linking the signal lights of the illuminated X-pack frame 600 to the native signaling of a vehicle.

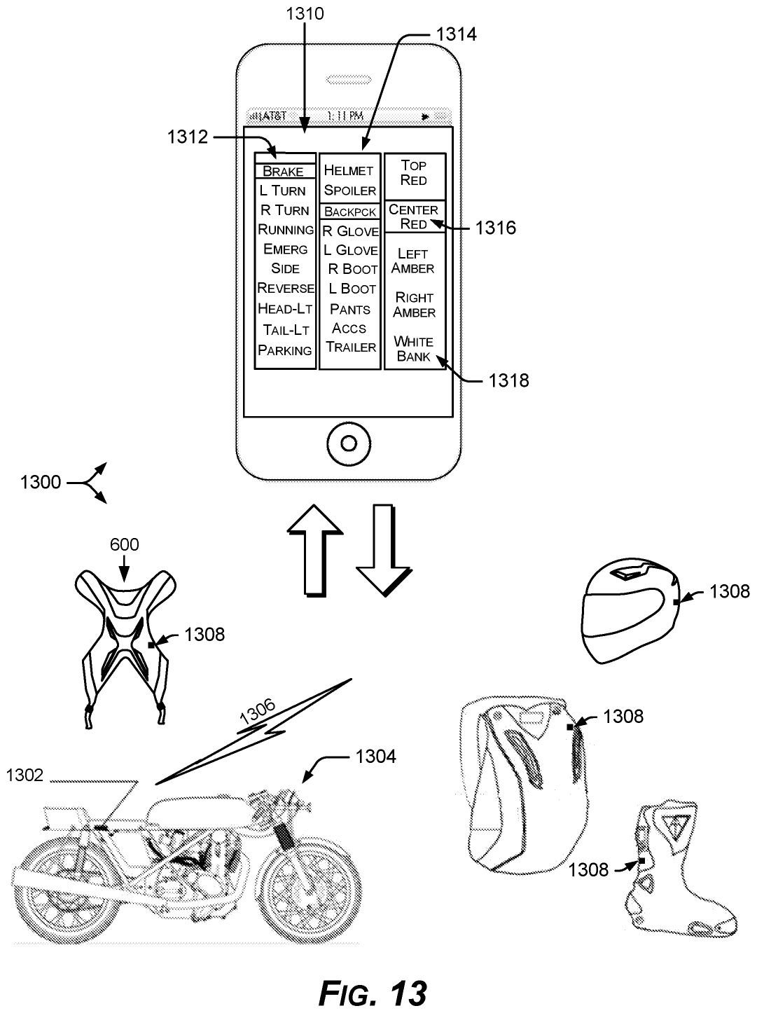

FIG. 13 shows an example vehicular signal and lighting system 1300 configurable to various illuminated articles and apparel. An example signal controller 1302 is attached to a vehicle 1304, such as a motorcycle. The signal controller 1302 is capable of receiving indicator signals from the vehicle 1304, by hardwiring, for example or other communicative coupling.

The signal controller 1302 includes a wireless transmitter and is capable of sending a wireless signal 1306 from the signal controller 1302 attached to the vehicle 1304 to one or more respective receivers or transceivers 1308 of the illuminated articles and apparel of the rider, such as the illuminated X-pack 600. The illuminated articles and apparel of the rider have been, or are capable of being dynamically associated, synced, or paired with the indicator signals of the vehicle 1304 via the signal controller 1302 of the vehicle 1304.

A user interface 1310 exposed by the mobile application enables the rider to dynamically assign each indicator signal 1312 of the vehicle 1304 to specific articles 1314 of the rider and to a specific light 1316 or to one or more banks of lights 1318 on each respective article dynamically assigned by the rider to the respective indicator signal 1312 of the vehicle 1304. The signal controller 1302 of the vehicle 1304 dynamically associates each signal received from the vehicle 1304 with one or more specific articles 1314 of the variety of articles and accessories associated with the rider or driver of the vehicle 1304. The signal controller 1302 of the vehicle 1304 also dynamically associates each indicator signal 1312 with a specific light 1316 or with one or more banks of lights 1318 on each of the one or more articles 1314 dynamically associated with the respective signal from the vehicle 1304.

The example system 1300 may enable the rider or user to compile multiple built-in sets of associations between the indicator signals 1312 of a given vehicle 1304 and the lights on articles of the rider, the sets of associations stored in a nonvolatile data storage medium of the user's mobile device. Each respective built-in set of associations is addressable by the rider via the mobile application.

An example system that allows a user to dynamically assign vehicle signals for activating brake lights, turn signals, running lights, headlights, police emergency lights, and so forth—to user-selected lights built into articles and apparel, such as the signal lights of the illuminated X-pack frame 600 is described in US Patent Publication 2019/0315268 to Garvey, which is incorporated herein by reference in its entirety. In the Garvey system, vehicle signals may be wirelessly assigned to lights on articles and apparel through the application residing on a phone, watch, tablet, or other device of the user. The system forms a self-managing wireless network, to which the user can add any number of additional illuminated articles and pieces of illuminated apparel, which are automatically sensed and integrated, and through the mobile application, program the characteristics and light qualities of the signal lights 602, 604, 606, 608, 610. This allows the signal lights of the example illuminated X-pack frame 600 to work in concert with other items of illuminated apparel that the rider (or even a passenger rider) might be wearing or carrying, such as motorcycle helmet(s), visors, illuminated coats, chaps, gloves, backpacks, trousers, shoes, boots, and so forth, that also have signal lights and receivers built-in, and can participate in the same wireless signaling network as the example illuminated X-pack frame 600.

The mobile application maps selected specific signal lights 602, 604, 606, 608, 610 of the illuminated X-pack frame 600 to native signaling functions of the rider's vehicle via the user interface 1310. For example, an implementation of the illuminated X-pack frame 600 may have many types of signal lights assignable to numerous functions and behaviors of the rider's vehicle. A given signal light on the illuminated X-pack frame 600 can be mapped to an emergency flasher function of the rider's vehicle. In another example, the brake function of a motorcycle or other vehicle can be mapped to a selection or an array of signal lights on the illuminated X-pack frame 600 that are not statically assigned to any particular function. The mobile application may also assign a signal color to a given signal light of the illuminated X-pack frame 600, when the given signal light, such as a multicolor LED, is capable of providing light output in multiple colors.

In other implementations, the mobile application does not perform basic mapping of signal lights of the illuminated X-pack frame 600 to signal functions of the vehicle, but does allow the user to select characteristics and behaviors of factory-mapped signal lights 602, 604, 606, 608, 610, for example.

The rider may choose LEDs of the brake lights 602 to function in various LED modes, such as solid color lighting 1102, flashing lights mode 1104, or LED burst mode 1106, for example, via user interface 1200. In an implementation, the mobile application has multiple user interface pages for comprehensive mapping and behavior programming of all signal lights 602, 604, 606, 608, 610 on the illuminated X-pack frame 600 and other illuminated accessories. The mobile application may also allow the user to toggle to an example manual mode, in which operation of the example signal lights 602, 604, 606, 608, 610 of the illuminated X-pack frame 600 are controlled manually by the rider or wearer, with manual turn signal buttons or lever, and manual brake button or lever. This is useful when the rider switches from a motorcycle or other vehicle with dedicated traffic signaling to a vehicle or sports equipment (or walking or running) without native signaling. Hence, the mobile application allows the signal lights of the illuminated X-pack frame 600 to be used without linking the signal lights to the native signaling of a vehicle.

In the Garvey system of US Patent Publication 2019/0315268, vehicle signal and lighting systems are configurable and assignable to various articles and apparel of a rider or user, along with the X-pack frame 600. An example system allows a rider or driver to assign vehicle signals for activating lights, such as headlights, running lights, side lights, police flashers, strobes, emergency lights, brake lights, turn signals, parking lights, direction lights (e.g., boats and trailers), reverse lights, accessory lights, and night-lights such as after-dark running lights: to user-selected (rider-selected) lights and banks of lights on a set of user-selected articles and apparel. The vehicle lighting signals may be wirelessly assigned from a given vehicle to lights on articles and apparel through the mobile application on a smart phone, smart watch, or tablet, etc., or on the vehicle's own dashboard with Bluetooth. Moreover, the mobile application can switch lighting assignments instantaneously between vehicles of the same type, and between vehicles of different types, such as between motorcycles, scooter, bicycles, cars, trailers, and so forth. Automatic light-assignment options are also available.

The Garvey system forms a self-managing wireless network, to which the user can add any number of additional illuminated articles and pieces of illuminated apparel, such as the example illuminated X-pack frame 600, which are automatically sensed and integrated. The Garvey system senses the newly added articles or apparel, and automatically expands the local wireless network to integrate the lighting on the newly added articles and pieces of apparel, such as the example illuminated X-pack frame 600, into the signaling assignments selected by the user for a given vehicle or type of vehicle.

In an implementation, there are one or more lights in, or on, the illuminated X-pack pack frame 600 that can be utilized in the Garvey system according to default or special assignment by the user of the illuminated X-pack frame 600. A receiver in the illuminated X-pack frame 600 may process a wireless signal from a vehicle or from a signal controller added to the vehicle, and the receiver is configured to assign at least one indicator function to the one or more lights based on the wireless signal. The receiver is also configured to actuate the one or more lights according to the assigned indicator functions, based on the received wireless signal. Brake lights, headlights, and turn signal lights, for example, can thus be actuated on the illuminated X-pack frame 600 based on the wireless signal.

Other features of the vehicular signaling system for illuminating the illuminated X-pack frame 600 are likewise described in US Patent Publication 2019/0315268 to Garvey.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

While the present disclosure has been disclosed with respect to a limited number of embodiments, those skilled in the art, having the benefit of this disclosure, will appreciate numerous modifications and variations possible given the description. It is intended that the appended claims cover such modifications and variations as fall within the true spirit and scope of the disclosure.

1. An apparatus, comprising:
a frame forming an X-shaped shell;
shoulder straps attached to the frame to make the frame wearable by a user;
a vertical notch in the X-shaped shell of the frame for receiving a cam of a detachable accessory pack to be secured between the frame and the user;
each detachable accessory pack conformed to one or more contours of the X-shaped shell; and
a collar of the frame for receiving, seating, and securing a neck portion of each detachable accessory pack.

2. The apparatus of claim 1, wherein the detachable accessory pack comprises a daypack possessing a first amount of storage space, the daypack further comprising an instance of the cam and an instance of the neck portion.

3. The apparatus of claim 1, wherein the detachable accessory pack comprises a weekend pack possessing a second amount of storage space greater than the first amount of storage space, the weekend pack further comprising an instance of the cam and an instance of the neck portion.

4. The apparatus of claim 1, wherein the detachable accessory pack comprises a skatepack possessing a sleeve for carrying a skateboard, the skatepack further comprising an instance of the cam and an instance of the neck portion.

5. The apparatus of claim 1, wherein the detachable accessory pack comprises a hydropack capable of transporting a fluid, the hydropack further comprising an instance of the cam and an instance of the neck portion.

6. The apparatus of claim 1, further comprising an inherent storage space within the frame or within the X-shaped shell of the frame.

7. The apparatus of claim 1, further comprising a light on the frame or on the X-shaped shell of the frame.

8. The apparatus of claim 1, further comprising an electronic receiver in the frame, the electronic receiver in communication with a vehicle of the user;
signal lights on the frame or on the X-shaped shell of the frame; and
wherein the electronic receiver actuates the signal lights on the frame or on the X-shaped shell of the frame to display traffic signals of the vehicle.

9. The apparatus of claim 8, wherein the signal lights on the frame or on the X-shaped shell of the frame include at least a brake light and a turn signal light.

10. An apparatus, comprising:
a frame forming an X-shaped shell;
shoulder straps attached to the frame to make the frame wearable by a user;
a vertical notch in the X-shaped shell of the frame for receiving a cam of a detachable accessory pack to be secured between the frame and the user;
a receiver in the frame to wirelessly communicate with a vehicle of the user; and
signal lights on the frame, the signal lights actuated by the receiver to duplicate a signaling of the vehicle.

11. The apparatus of claim 10, wherein the signal lights comprise a brake light and a turn signal light.

12. The apparatus of claim 11, wherein the brake light comprises an X-shape with four arms, the brake light approximating the X-shape shell of the frame at a smaller scale than the X-shaped shell.

13. The apparatus of claim 12, wherein each of the four arms of the brake light in the X-shape has an associated turn signal light.

14. The apparatus of claim 12, wherein the brake light in the X-shape with four arms is curved in 3-dimensions over the X-shaped shell of the frame to be visible from multiple points of view around the user.

15. The apparatus of claim 10, wherein the shoulder straps include front-facing turn signal lights.

16. The apparatus of claim 10, further comprising a claspable cross-strap for securing the shoulder straps together into a harness.

17. The apparatus of claim 10, wherein the signal lights of the frame are user-mappable to the signaling of the vehicle via a mobile application.

18. The apparatus of claim 17, wherein the mobile application enables the user to adjust color, brightness, flash, dimming, blink frequency, and blink duration characteristics of the signal lights.

19. The apparatus of claim 10, wherein the signal lights include emergency flashers actuated by the receiver.

20. The apparatus of claim 10, wherein the detachable accessory pack comprises one of a daypack, a weekend pack, a hydropack, or a skatepack, each instance of the detachable accessory pack comprising a neck portion to mate with a collar of the frame.
